(19) United States
(12) Patent Application Publication
(10) Pub. No.: US 2015/0352739 A1
(43) Pub. Date: Dec. 10, 2015

(54) Apparatus for Cutting Food

(71) Applicants: Aurelio ARMANDO, Caraglio (Cuneo) (IT); Diego ARMANDO, Caraglio (Cuneo) (IT)

(72) Inventors: Aurelio Armando, Caraglio (Cuneo) (IT); Diego Armando, Caraglio (Cuneo) (IT); Valerio Armando, Caraglio (Cuneo) (IT)

(73) Assignees: Diego Armando, Caraglio (Cuneo) (IT); Aurelio Armando, Caraglio (Cuneo) (IT)

(21) Appl. No.: 14/760,884

(22) PCT Filed: Jan. 16, 2014
(86) PCT No.: PCT/IB2014/058327

§ 371 Date: Jul. 14, 2015

(30) Foreign Application Priority Data
Jan. 21, 2013 (IT) TO2013A000047

(51) Int. Cl. B26D 5/22; B26D 7/26; B26D 7/06; B26D 5/12; B26D 5/16; B26D 5/26; B26D 7/22; B26D 1/30

(52) U.S. Cl. CPC B26D 5/22; B26D 7/225; B26D 7/26; B26D 1/30; B26D 5/12; B26D 5/16; B26D 5/26; B26D 7/0666

(57) ABSTRACT

The apparatus comprises: a supporting frame; a dish (14) rotatably mounted about an axis (16) on the frame and carrying the food to be cut; at least one knife (20) hinged about a pivot (18) fixed to the frame and provided with elastic return means, so that it can swing in a plane orthogonal to the dish (14); a first shaft actuating the rotation movement of the dish (14) about the axis (16); a camshaft (30, 32) actuating the swinging movement of the knife (20); and means connecting the first shaft and the camshaft (30, 32).

The present invention relates to an apparatus for cutting food, for example meat, cured meat or vegetables, which is suitable in particular for preparing what is termed “sliced meat”.

The latter is typically prepared by butchers directly operating a knife to subdivide a piece of meat into slices. However, this preparation is time-consuming and has to be carried out by an expert.

U.S. Pat. No. 3,696,849 describes an apparatus for cutting food, comprising a knife pivoted at one end so as to be able to swing in a plane substantially orthogonal to a fixed base.

It is an object of the present invention to provide an apparatus which makes it possible to speed up the cutting operation and which can be operated even by people without specific skills and experience.

According to the invention, this object is achieved by an apparatus comprising:
a supporting frame,
a dish rotatably mounted about an axis on the frame, said dish carrying the food to be cut,
at least one knife hinged to the frame and provided with elastic return means, so that it can swing in a plane substantially orthogonal to said dish, and
coupled means for actuating both the swinging movement of said at least one knife and the rotation movement of said dish.

The means for actuating the swinging movement of the at least one knife and the rotation movement of the dish are connected in particular in such a way as to ensure that intervals of rest of the rotation movement of the dish correspond to periods of time in which the knife is lowered, that is performs the actual cut. This connection can be made, for example, by providing the apparatus with an electronic unit for controlling electric motors which actuate the aforementioned movements, or by means of mechanical devices which coordinate them in the desired manner.

The apparatus of the invention can be operated both manually and electrically, and is suitable for use both domestically and in a professional/industrial environment.

In both cases, it makes it possible to conveniently cut food, avoiding both overheating and crushing. In particular, the manual operated embodiment acts on the food in a similar manner to that for a traditional cut, with the advantages that the operation is sped up owing to the use of a number of knives and a high cutting frequency and the effort on the part of the operator is minimized, who additionally is not required to have any specific expertise.

A further advantageous property of the apparatus of the invention is that it is possible to cut food in the desired thickness by simply varying the geometrical characteristics thereof, for example the diameter of pulleys fixed to respective ends of the first actuating shaft and of the camshaft.

Further advantages and features of the present invention will become evident from the detailed description which follows, which is provided by way of non-limiting example with reference to the accompanying drawings, in which:

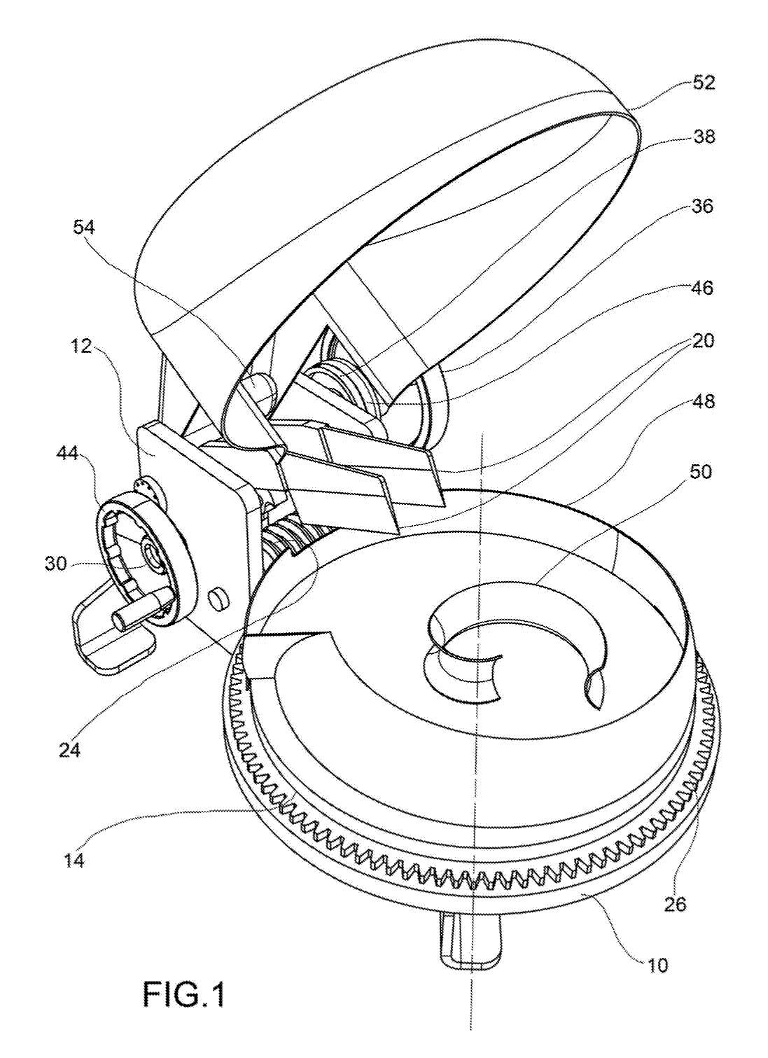

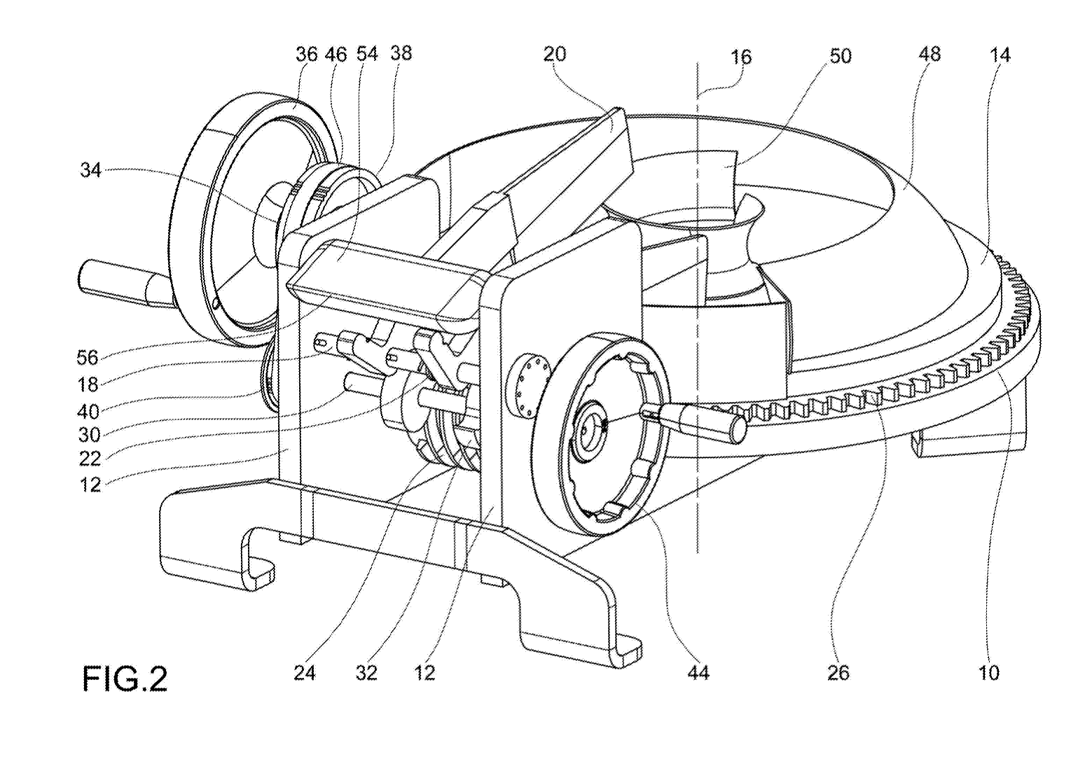

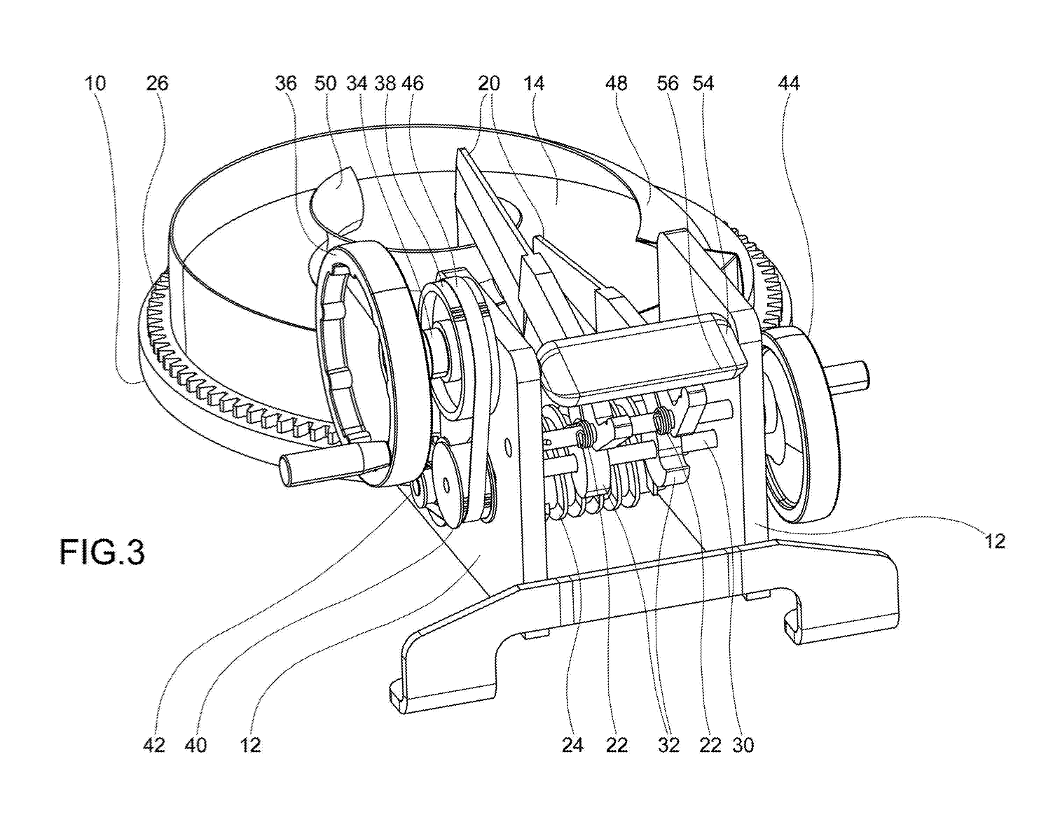

FIGS. 1 to 3 are perspective views from different angles of an apparatus of the invention, if need be with external housing parts removed for greater illustrative clarity.

An apparatus for cutting food has a supporting frame which includes a circular base 10 and a pair of facing brackets 12 located adjacent to a portion of the latter.

A circular dish 14 having a substantially vertical central axis 16 is mounted rotatably on the base 10 by means of conventional bearings not shown.

A pivot 18, on which respective ends of sharp knives 20 provided with respective elastic return means are hinged, is fixed between the brackets 12. Said elastic return means consist of a helical spring 22 having an end fixed to the pivot 18 and the opposite end fixed to the knife 20. As will become apparent from the description of operation below, each knife 20 can swing in a respective plane identified by the orientation of its blade, which is substantially orthogonal to the dish 14.

A first shaft for actuating the rotation movement of the dish 14 about the axis 16 is also mounted between the brackets 12. This shaft is an endless screw 24 meshing with a toothed crown 26 circumferentially extending around the periphery of the dish 14. The thread of the screw 24 has a succession of tracts alternatively lying in planes inclined and in planes perpendicular with respect to the axis of the screw 24.

A camshaft 30 for actuating the swinging movement of the knives 20 is also mounted between the brackets 12: in particular, provision is made of a respective suitably profiled cam 32 thereof which interacts with each knife 20.

A second actuating shaft 34, on which an actuating hand-wheel 36 and a pulley 38 are fixed, is also mounted on one of the brackets 12.

Respective pulleys 40, 42 are fixed to the ends of the screw 24 and of the shaft 30 which protrude from the flange 12 on which the second shaft 34 is mounted. A flywheel 44, which can act also as an actuating hand-wheel, is fixed to the opposite end of the shaft 30.

A flexible element 46, such as a belt, a rope or a chain, is wound around all of the pulleys 38, 40, 42, which are arranged in a triangle, thereby acting as a means for connecting the shafts on which the latter are fixed.

An external wall 48 and an internal wall 50, creating a progressively narrowing spiralling path on the surface of the dish 14, are fixed to the base 10 of the frame. The walls 48, 50 have in cross section a curved shape, the external wall 48 being outwardly convex and the internal wall 50 being inwardly convex.

A cover 52, intended to cover the dish 14 and the knives 20, is fixed to a pivot 54, which is rotatably mounted between the brackets 12 and has a protuberance 56 over its entire axial extent.

The operation of the apparatus described above is as follows.

The food, in particular meat, to be cut is placed on the dish 14, and then, by making the hand-wheel 36 (or the flywheel 44 if it is preferred to operate from the opposite side of the apparatus) rotate, the simultaneous rotation of the endless screw 24 and of the camshaft 30 is brought about, owing to the flexible connecting element 46. In turn, the endless screw 24, which meshes with the toothed crown 26, brings about the rotation of the dish 14 carrying the food, which is thereby guided under the knives 20 also by the action of the walls 48, 50, which create a progressively narrowing spiralling path.

At the same time, the rotating cams 32 interact with the respective knife 20, overcoming the torsional resistance afforded by the respective springs 22 and causing a swinging cutting movement in a plane orthogonal to the dish 14.

It is to be noted that, owing to the fact that the thread of the screw 24 has a succession of tracts alternatively lying in planes inclined and in planes perpendicular with respect to its axis, the rotation movement of the dish 14 is not continuous, but rather takes place at intervals. In particular, the intervals of stop correspond to the periods of time in which the knives 20 are lowered. In this way, the cutting action is made on the food which is stationary, thereby avoiding undesired fraying and crushing. The force with which the knives 20 strike against the food can be regulated by varying the rigidity of the springs 22. The relationship between the frequency of the swinging movement of the knives 20 and the angular rotational velocity of the dish 14, which determines the thickness of the food cut, depends on the dimensional relationship which exists between the pulleys 40, 42, which can thus be selected in a desired manner. The curved shape of the walls 48, 50 and the narrowing of the path which they define on the dish 14 further promote the execution of the cutting operation.

It goes without saying that, during the cutting operation, the cover 52 is lowered, so as to prevent food escaping to the outside of the apparatus and to protect the operator. On the other hand, when the cover 52 has been raised so as to make it possible to handle the food which has been cut/is to be cut, the rotation of the respective pivot 54 has caused interaction between its protuberance 56 and the knives 20, which have thus been raised and positioned outside of the operating range of the cams 32, thereby preventing them from any further movement.

Of course, without affecting the principle of the invention, the details of realization and the embodiments may differ considerably with respect to those described purely by way of example, without thereby departing from the scope of the invention as defined in the accompanying claims. By way of example, the apparatus of the invention could be operated electrically and/or provide for any desired number of knives, possibly pivoted on a number of different pivots. Furthermore, the various shafts can be connected by means of reciprocally meshing toothed wheels rather than by means of a flexible element, or provision can be made for the presence of a gear motor. Moreover, the at least one knife can be hinged indirectly on the frame, by means of one or more intermediate articulation elements, and/or can be provided with a gas spring as elastic return means. For their part, the means for actuating the swinging movement of this knife can include an electrical actuator or a fluidic cylinder, in particular a pneumatic cylinder, instead of a camshaft.

The scope of the present invention also includes an apparatus in which the means for actuating both the swinging movement of the at least one knife and the rotation movement of the dish are connected by an electronic control unit: by way of example, use can be made of two different electric motors, the operation of which is coordinated by the electronic unit, so as to ensure that, in the periods of time in which the knives are lowered—that is during the actual cutting phases—the dish remains stationary.

1. Apparatus for cutting food, comprising:
a supporting frame,
a dish (14) rotatably mounted about an axis (16) on the frame, said dish (14) carrying the food to be cut,
at least one knife (20) hinged to the frame and provided with elastic return means, so that it can swing in a plane substantially orthogonal to said dish (14), and
coupled means for actuating both the swinging movement of said at least one knife (20) and the rotation movement of said dish (14).

2. Apparatus according to claim 1, further comprising:
a first shaft actuating the rotation movement of the dish (14) about the axis (16),
a camshaft (30, 32) actuating the swinging movement of said at least one knife (20), and means connecting said first shaft and camshaft (30, 32).

3. Apparatus according to claim 1, wherein said at least one knife (20) is hinged about a pivot (18) associated with, in particular fixed to, the supporting frame.

4. Apparatus according to claim 2, wherein said first actuating shaft is an endless screw (24) meshing with a toothed crown (26) circumferentially extending around the periphery of the dish (14).

5. Apparatus according to claim 4, wherein the thread of said screw (24) has a succession of tracts alternatively lying in planes inclined and in planes perpendicular with respect to its axis.

6. Apparatus according to claim 2, wherein said connecting means consist of a flexible element (46), such as a belt, a rope or a chain, winding pulleys (40, 42) fixed to an end of the first shaft and of the camshaft (30, 32), respectively.

7. Apparatus according to claim 6, wherein a flywheel (44), which can act also as an actuating hand-wheel, is fixed to the opposite end of the camshaft (30, 32).

8. Apparatus according to claim 6, comprising a second actuating shaft (34), on which an actuating hand-wheel (36) and a respective pulley (38), about which said flexible element (46) is wound, are fixed.

9. Apparatus according to claim 3, wherein said elastic means consist of a helical spring (22) having an end fixed to the pivot (18) and the opposite end fixed to the knife (20).

10. Apparatus according to claim 1, wherein an external wall (48) and an internal wall (50), creating a progressively narrowing spiralling path for the food which is carried under the knife (20) by the rotation of the dish (14), are fixed to said frame.

11. Apparatus according to claim 10, wherein said walls (48, 50) have in cross section a curved shape, the external wall (48) being outwardly convex and the internal wall (50) being inwardly convex.

12. Apparatus according to claim 2, comprising a cover (52) covering said dish (14) and said at least one knife (20), said cover (52) being fixed to a pivot (54) rotatably mounted between two brackets (12) of the frame, and said pivot (54) having a protuberance (56) that, when the cover (52) is raised, brings about the lifting of said knife (20) too, impeding the interaction thereof with said cams (32).

13. Apparatus according to claim 1, wherein said means for actuating the swinging movement of said at least one knife (20) include an electrical actuator or a fluidic cylinder, in particular a pneumatic cylinder.

14. Apparatus according to claim 1, wherein said elastic return means of said at least one knife (20) consist of a gas spring.

15. Apparatus according to claim 1, wherein said means for actuating the swinging movement of the at least one knife (20) and the rotation movement of the dish (14) are connected in such a way as to ensure that intervals of stop of the rotation movement of the dish (14) correspond to periods of time in which the knife (20) is lowered.

16. Apparatus according to claim 1 comprising an electronic unit for controlling said means for actuating the swinging movement of said at least one knife (20) and the rotation movement of said dish (14).

17. Apparatus according to claim 15, comprising an electronic unit for controlling said means for actuating the swinging movement of said at least one knife (20) and the rotation movement of said dish (14).
